(19) United States
(12) Patent Application Publication
(10) Pub. No.: US 2026/0169900 A1
(43) Pub. Date: Jun. 18, 2026

(54) SMART TEST CASE SELECTION METHOD WITH PERFORMANCE INFLUENCING FACTORS CONSIDERED

(71) Applicant: Dell Products L.P., Round Rock, TX (US)

(72) Inventor: Huijuan Fan, Chengdu (CN)

(73) Assignee: Dell Products L.P., Round Rock, TX (US)

(21) Appl. No.: 19/008,796

(22) Filed: Jan. 3, 2025

(30) Foreign Application Priority Data
Dec. 17, 2024 (CN) 202411863790.6

(51) Int. Cl. G06F 11/3668

(52) U.S. Cl. CPC G06F 11/3684

(57) ABSTRACT

Methods, system, and non-transitory processor-readable storage medium for a test selection system are provided herein. An example method includes periodically updating dynamic performance attributes and static attributes of a plurality of test cases, where the dynamic performance attributes comprise performance information collected from a plurality of historical test case executions. The test selection system receives a target test scenario comprising recommended test attribute information and obtains current static and dynamic performance attributes for the plurality of test cases. The test selection system calculates similarity matching scores between each test case and the target test scenario, then calculates cosine similarity between reduced dimension attributes of each test case and the target test scenario. The test selection system selects test cases from the plurality of test cases having similarity matching scores greater than or equal to a threshold value, and outputs a test case plan list comprising the selected test cases.

### FIELD

The field relates generally to optimizing selection of test cases, and more particularly to optimizing the selection of test cases taking into consideration performance influencing factors in information processing systems.

### BACKGROUND

Test case execution is the important phase of the software testing life cycle (STLC) and the entire software development. This process involves not only including the regular test case execution, but also targeted case design and selection before execution to resolve specific test issues.

### SUMMARY

Illustrative embodiments provide techniques for implementing a test selection system in a storage system. For example, illustrative embodiments periodically update, by the test selection system, dynamic performance attributes and static attributes of a plurality of test cases, where the dynamic performance attributes comprise performance information collected from a plurality of historical test case executions. The test selection system receives a target test scenario comprising recommended test attribute information. The test selection system obtains current static and dynamic performance attributes for the plurality of test cases. The test selection system calculates similarity matching scores between each test case and the target test scenario. The test selection system calculates cosine similarity between reduced dimension attributes of each test case and the target test scenario. The test selection system selects test cases from the plurality of test cases having similarity matching scores greater than or equal to a threshold value. The test selection system outputs a test case plan list comprising the selected test cases. Other types of processing devices can be used in other embodiments. These and other illustrative embodiments include, without limitation, apparatus, systems, methods and processor-readable storage media.

### BRIEF DESCRIPTION OF THE DRAWINGS

FIG. 1 shows an information processing system including a test selection system, in an illustrative embodiment.

FIG. 2 shows a flow diagram of a process for a test selection system, in an illustrative embodiment.

FIG. 3. illustrates a workflow of the test selection system, in an illustrative embodiment.

FIGS. 4 and 5 show examples of processing platforms that may be utilized to implement at least a portion of the test selection system embodiments.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

Described below is a technique for use in implementing a test selection system, which technique may be used to provide, among other things, intelligent test case selection with performance influencing factors taken into consideration by periodically updating, by the test selection system, dynamic performance attributes and static attributes of a plurality of test cases, where the dynamic performance attributes comprise performance information collected from a plurality of historical test case executions. The test selection system receives a target test scenario comprising recommended test attribute information. The test selection system obtains current static and dynamic performance attributes for the plurality of test cases. The test selection system calculates similarity matching scores between each test case and the target test scenario. The test selection system calculates cosine similarity between reduced dimension attributes of each test case and the target test scenario. The test selection system selects test cases from the plurality of test cases having similarity matching scores greater than or equal to a threshold value. The test selection system outputs a test case plan list comprising the selected test cases.

In software testing, the effective selection of test cases plays a vital role in maintaining product quality and addressing customer issues. Current approaches rely heavily on static, pre-defined parameters, which often fail to capture the dynamic nature of software performance. For example, typically, when test cases are designed, configuration parameters and feature tags are pre-defined. An example test case x has parameters such as “100 NFS share with each size 100 GB, 20 snapshots for each NFS, node A reboot”, and feature tags such as “ILD, SRS, vdbench IO, space reclaim”. However, these items are static and pre-defined, and cannot reflect all the testing coverage provided by a given test case, especially the performance information which dynamically occurs during test execution. Embodiments disclosed herein provide an intelligent test case selection mechanism that incorporates performance metrics alongside traditional parameters. By analyzing real-world examples from customer implementations, the test selection system improves issue reproduction, bug verification, and overall testing efficiency. Embodiments disclosed herein provide more comprehensive test coverage and faster resolution of both customer-reported issues and internal software defects.

For example, a customer reported performance degradation with high latencies during specific hours and extended login times in their VDI environment. An investigation revealed the issue extended beyond VDI scenarios, affecting various host environments during data prefilling and page flush processes. The initial focus on VDI configuration overlooked crucial performance-related test cases. In another example, involving recurring node panics with replication volumes, verification required testing beyond basic replication scenarios. Additional testing was needed to include scenarios with similar performance characteristics that could trigger increased internal IO request traffic, potentially leading to resource starvation and node panics.

Conventional technologies for selecting test cases for specific test failures fail to combine static parameters and/or matching feature tags with historical test case performance to optimize test case selection. Conventional technologies fail to consider performance influencing factors when selecting test cases.

By contrast, in at least some implementations in accordance with the current technique as described herein, intelligent test case selection with performance influencing factors taken into consideration is achieved by periodically updating, by the test selection system, dynamic performance attributes and static attributes of a plurality of test cases, where the dynamic performance attributes comprise performance information collected from a plurality of historical test case executions. The test selection system receives a target test scenario comprising recommended test attribute information. The test selection system obtains current static and dynamic performance attributes for the plurality of test cases. The test selection system calculates similarity matching scores between each test case and the target test scenario. The test selection system calculates cosine similarity between reduced dimension attributes of each test case and the target test scenario. The test selection system selects test cases from the plurality of test cases having similarity matching scores greater than or equal to a threshold value. The test selection system outputs a test case plan list comprising the selected test cases.

Thus, a goal of the current technique is to provide a method and a system for delivering a test selection system that can produce an optimized and efficient test plan to target both external customer issues and internal bug issues. Another goal is to combine static parameters and/or matching feature tags with historical test case performance to optimize test case selection. Yet another goal is to consider performance influencing factors when selecting test cases.

In at least some implementations in accordance with the current technique described herein, the use of a test selection system can provide one or more of the following advantages: produce an optimized and efficient test plan to target both external customer issues and internal bug issue, combine static parameters and matching feature tags with historical test case performance to optimize test case selection, and consider performance influencing factors when selecting test cases.

In contrast to conventional technologies, in at least some implementations in accordance with the current technique as described herein, intelligent test case selection with performance influencing factors taken into consideration is achieved by periodically updating, by the test selection system, dynamic performance attributes and static attributes of a plurality of test cases, where the dynamic performance attributes comprise performance information collected from a plurality of historical test case executions. The test selection system receives a target test scenario comprising recommended test attribute information. The test selection system obtains current static and dynamic performance attributes for the plurality of test cases. The test selection system calculates similarity matching scores between each test case and the target test scenario. The test selection system calculates cosine similarity between reduced dimension attributes of each test case and the target test scenario. The test selection system selects test cases from the plurality of test cases having similarity matching scores greater than or equal to a threshold value. The test selection system outputs a test case plan list comprising the selected test cases.

In an example embodiment of the current technique, the dynamic performance attributes comprise central processing unit (CPU) usage, memory usage, Input/Output Operations Per Second (IOPS), and latency.

In an example embodiment of the current technique, the plurality of historical test case executions is based on at least one of selecting a predetermined number of latest historical test case executions and selecting historical test case executions occurring after a specified time.

In an example embodiment of the current technique, selecting historical test case executions occurring after a specified time comprises selecting test executions that occurred after a specified calendar date.

In an example embodiment of the current technique, the static attributes comprise hardware configurations, software configurations, and feature tags.

In an example embodiment of the current technique, the hardware configurations comprise at least one of hardware type, disk configuration, and power action support.

In an example embodiment of the current technique, the software configurations comprise at least one of network file system (NFS) version, replication session count, node reboot settings, execution duration, and database type.

In an example embodiment of the current technique, the feature tags comprise at least one of inline data reduction (ILD), space reclaim, prefetch, and feature identifiers.

In an example embodiment of the current technique, the performance information is collected from test executions performed on an array system, and where the performance information reflects array performance while a test case is executed on the array.

In an example embodiment of the current technique, the test selection system calculates an average performance value using weighted performance information from the plurality of historical test case executions.

In an example embodiment of the current technique, the test selection system applies weights to performance information from each selected historical test case execution, where a sum of the weights equals one.

In an example embodiment of the current technique, the weights are equal for each selected historical test case execution.

In an example embodiment of the current technique, the target test scenario is provided by an expert based on a new requirement, where the new requirement comprises at least one of an external customer issue or an internal fixed bug issue.

In an example embodiment of the current technique, the test selection system performs dimension reduction on the static and dynamic performance attributes using multidimensional scaling (MDS) to generate the reduced dimension attributes.

In an example embodiment of the current technique, the test selection system reduces each of the static and dynamic performance attributes to a same number of dimensions.

In an example embodiment of the current technique, the test selection system reduces each of the static and dynamic performance attributes to avoid an imbalance of weights among the static and dynamic attributes.

In an example embodiment of the current technique, the test selection system generates a distance matrix representing Euclidean distances between test case attributes.

In an example embodiment of the current technique, the test selection system calculates similarity between vector representations of the reduced dimension attributes.

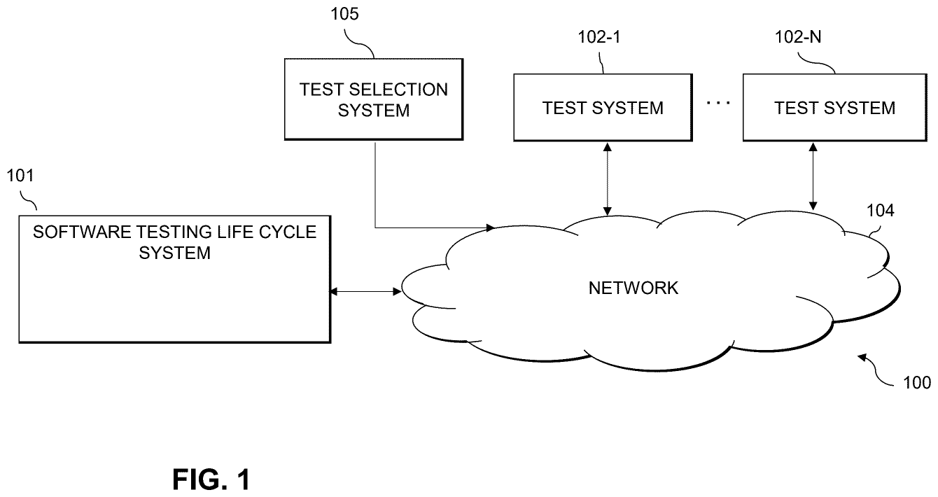

FIG. 1 shows a computer network (also referred to herein as an information processing system) 100 configured in accordance with an illustrative embodiment. The computer network 100 comprises a software testing life cycle system 101, test selection system 105, and test systems 102-N. The software testing life cycle system 101, test selection system 105, and test systems 102-N are coupled to a network 104, where the network 104 in this embodiment is assumed to represent a sub-network or other related portion of the larger computer network 100. Accordingly, elements 100 and 104 are both referred to herein as examples of “networks,” but the latter is assumed to be a component of the former in the context of the FIG. 1 embodiment. Also coupled to network 104 is a test selection system 105 that may reside on a storage system. Such storage systems can comprise any of a variety of different types of storage including network-attached storage (NAS), storage area networks (SANs), direct-attached storage (DAS) and distributed DAS, as well as combinations of these and other storage types, including software-defined storage.

Each of the test systems 102-N may comprise, for example, servers and/or portions of one or more server systems, as well as devices such as mobile telephones, laptop computers, tablet computers, desktop computers or other types of computing devices. Such devices are examples of what are more generally referred to herein as “processing devices.” Some of these processing devices are also generally referred to herein as “computers.”

The test systems 102-N in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Also associated with the test selection system 105 are one or more input-output devices, which illustratively comprise keyboards, displays or other types of input-output devices in any combination. Such input-output devices can be used, for example, to support one or more user interfaces to the test selection system 105, as well as to support communication between the test selection system 105 and other related systems and devices not explicitly shown. For example, a dashboard may be provided for a user to view a progression of the execution of the test selection system 105. One or more input-output devices may also be associated with any of the test systems 102-N.

Additionally, the test selection system 105 in the FIG. 1 embodiment is assumed to be implemented using at least one processing device. Each such processing device generally comprises at least one processor and an associated memory, and implements one or more functional modules for controlling certain features of the test selection system 105.

More particularly, the test selection system 105 in this embodiment can comprise a processor coupled to a memory and a network interface.

The processor illustratively comprises a microprocessor, a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows the test selection system 105 to communicate over the network 104 with the software testing life cycle system 101, and test systems 102-N and illustratively comprises one or more conventional transceivers.

A test selection system 105 may be implemented at least in part in the form of software that is stored in memory and executed by a processor, and may reside in any processing device. The test selection system 105 may be a standalone plugin that may be included within a processing device.

It is to be understood that the particular set of elements shown in FIG. 1 for test selection system 105 involving the software testing life cycle system 101, and test systems 102-N of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, one or more of the test selection system 105 can be on and/or part of the same processing platform.

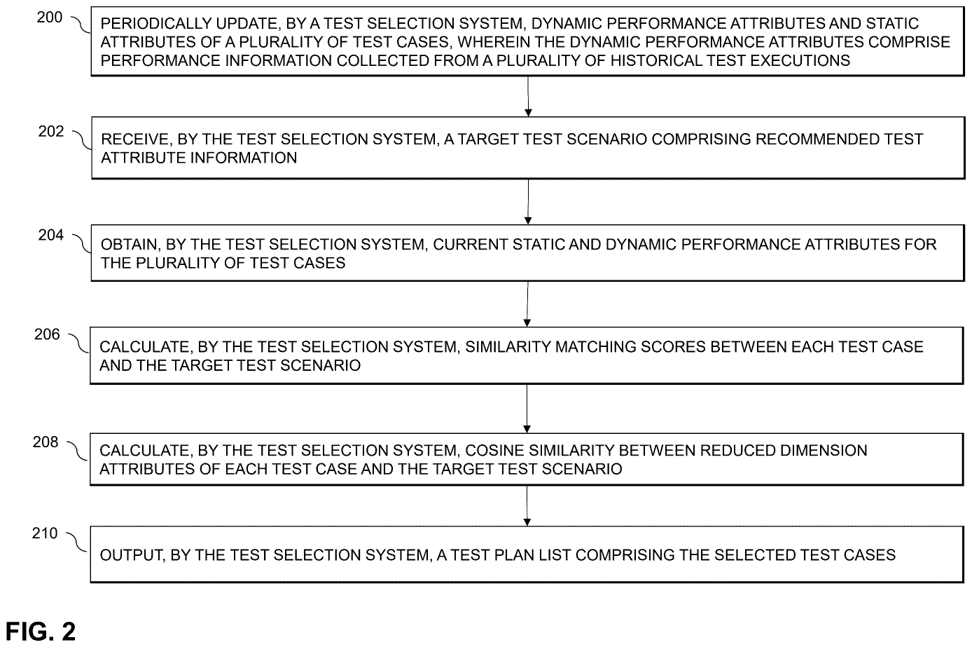

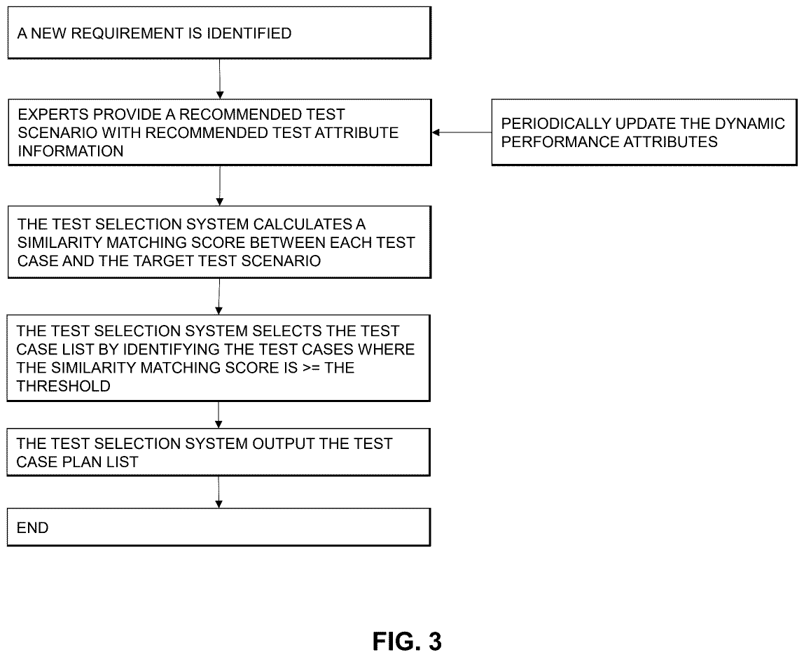

An exemplary process of test selection system 105 in computer network 100 will be described in more detail with reference to, for example, the flow diagram of FIG. 2.

FIG. 2 is a flow diagram of a process for execution of the test selection system 105 in an illustrative embodiment. It is to be understood that this particular process is only an example, and additional or alternative processes can be carried out in other embodiments.

The software testing life cycle (STLC) system 101 is a process that ensures thorough evaluation of software applications through distinct phases. The cycle typically begins with requirements analysis, where test requirements are gathered and reviewed. This is followed by test planning, where testing strategy, resources, and schedules are determined. During test case development, detailed test cases are created based on requirements specifications. The test environment setup phase involves preparing the necessary hardware, software, and network configurations. Test execution then occurs, where test cases are systematically run against the system under test, with results being documented and defects logged. Test cases are executed through both manual and automated means, using testing frameworks and tools that can simulate various user interactions and system conditions. The execution phase includes regression testing to ensure new changes haven't affected existing functionality, and performance testing to evaluate system behavior under different loads. Finally, test closure activities involve analyzing test results, generating reports, and documenting lessons learned for future testing cycles.

At 200, the test selection system 105 periodically updates dynamic performance attributes and static attributes of a plurality of test cases, where the dynamic performance attributes comprise performance information collected from a plurality of historical test case executions. In an example embodiment, test case attributes refer to property values that are pre-defined at the test case design stage.

In an example embodiment, dynamic attributes comprise the performance information that occurs during the execution of the test cases. In an example embodiment, the dynamic performance attributes comprise CPU usage, memory usage, IOPS (Input/Output Operations Per Second), and latency.

Static attributes may be defined by test designers based on their experience and requirements. In an example embodiment, the static attributes comprise hardware configurations, software configurations, and feature tags. In an example embodiment, the hardware configurations may comprise at least one of hardware type, disk configuration, and power action support. In an example embodiment, the software configurations may comprise network file system (NFS) version, replication session count, node reboot settings, execution duration, and database type. In an example embodiment, the software configuration (such as a particular disk I/O workload generator to be used in parallel on, for example, 100 volumes) may be defined. In an example embodiment, the feature tags comprise at least one of inline data reduction (ILD), space reclaim, prefetch, and feature identifiers.

In an example embodiment, the plurality of historical test case executions is based on at least one of selecting a predetermined number of latest historical test case executions and selecting historical test case executions occurring after a specified time. In an example embodiment, the selected historical test case executions occur after a specified time, such as test executions that occurred after a specified calendar date. Typically, performance may be collected by selecting the latest test execution data. However, one specific test execution may not be enough data to represent the performance of a given target scenario and may not be the performance that most closely mimics the target scenario. At the same time, the more recent the test case execution time is, the more valuable that performance data is. In an example embodiment, the test selection system 105 selects the latest K historical test case executions (for example, where K=3). In an example embodiment, the test selection system 105 selects the historical test case executions that occurred after a different given time T. In an example embodiment, T may be a specific date, such as Jan. 1, 2024.

In an example embodiment, a user may determine which of the two above methods are used to determine which historical test executions to use when calculating the average performance value when evaluating the test cases' similarity.

In an example embodiment, the performance information is collected from test executions performed on an array system, where the performance information reflects array performance while a test case is executed on the array. Typically, the array performance is measured by at least 4 criteria, central processing unit (CPU) usage, memory usage, input/output per second (IOPS), and latency. Test cases are composed of many test steps that exercise different features on a test system 102-N. Different features operating across the test system 102-N put pressure on the array system from different performance aspects, such as CPU usage, memory usage, IOP and latency.

In an example embodiment, the test selection system 105 calculates an average performance value using weighted performance information from the plurality of historical test case executions. In an example embodiment, the test selection system 105 calculates the average performance value by applying weights to performance information from each selected historical test case execution, where a sum of the weights equals one. In an example embodiment, the weights are equal for each selected historical test case execution. In an example embodiment, the average performance value is calculated as follows:

$${Perf}_{avg} = {\sum }_{all selected history executions} {ω}_{execution} \cdot {Perf}_{execution}$$

In an example embodiment, Perf_{execution} represents the performance information, such as CPU, MEM, IOPS and latency of the selected test case execution record. In an example embodiment, this performance information is obtained via an existing system application programming interface (API). In an example embodiment, users may define additional performance attributes according to real work requirements. The value ω_{execution} represents the weights of performance information of the selected test case execution record. The value Σ_{all selected history executions}ω_{execution} is set equal to 1. In an example embodiment, the weights are tuned to achieve better overall balancing results. In an example embodiment, it is assumed that each weight of test case execution is equal:

$${ω}_{execution} = 1 / count of selected history executions$$

In an example embodiment, TC represents the plurality of test cases (i.e., the test case set), TC=[tc₁, tc₂, . . . tcₘ]. In an example embodiment, the attributes that are defined before the execution of the test case are represented as hw (the test case's hardware configurations, such as Riptide, CM6L, disks, power action supported, etc.), sw (the test case's software configurations, such as 200 NFS v3, 100 replication session, node reboot, 73 hours, OracleDB, etc.), tag represents the test case's feature tag (such as ILD, space reclaim, prefetch, trif-1555, etc.), and perf (the test case's performance status when it is executed on an array, such as CPU, MEM, IOPS, and latency). These can be expanded according to a customer's requirements.

At 202, the test selection system 105 receives a target test scenario comprising recommended test attribute information. In an example embodiment, the target test scenario is provided by an expert based on a new requirement, where the new requirement comprises at least one of an external customer issue or an internal fixed bug issue.

In an example embodiment, when a new testing requirement comes in, an expert may provide a recommended test scenario, along with a series of recommended test attribute information. The test selection system 105 receives this information as the target test scenario.

At 204, the test selection system 105 obtains the current static and dynamic performance attributes for the plurality of test cases.

At 206, the test selection system 105 calculates similarity matching scores between each test case and the target test scenario. In an example embodiment, the test selection system 105 performs dimension reduction on the static and dynamic performance attributes using multidimensional scaling (MDS) to generate the reduced dimension attributes.

In an example embodiment, the test selection system 105 utilizes a multidimensional scaling algorithm to the process the hw, sw, tag, and perf attribute data into a lower-dimensional representation. Multidimensional scaling used as a means of visualizing the level of similarity of individual test cases of a dataset. The test case set of TC=[tc₁, tc₂, . . . tcₘ] contains M test cases, where each test case in the test case set is defined with N attributes; X₁, X₂, . . . X_{N}. Using one of the attribute datum, hw, each test case is linked with N hardware configuration items, hw₁, hw₂, . . . , hw_{N}. In many instances, the number of hardware configurations in a test case is a very large number. In an example embodiment, the test selection system 105 reduces each of the static and dynamic performance attributes to a same number of dimensions. In an example embodiment, the test selection system 105 performs dimension reduction using the multidimensional algorithm. In an example embodiment, the test selection system 105 generates a distance matrix representing Euclidean distances between test case attributes. For example, the distance matrix of the test case attributes is defined as D, where dᵢⱼ represents the Euclidean distance between the i^{th} and j^{th} test case attributes, and dᵢⱼ=∥xᵢ−xⱼ∥. In this example embodiment, “x” can be any of the hw, sw, tag and perf attributes. In an example embodiment, the test selection system 105 reduces each of the static and dynamic performance attributes to a same number of dimensions. For example, the test selection system 105 reduces these attributes to the same L dimension (in this example embodiment, L=4).

$$D = ( \begin{matrix}{d}_{11} & ⋯ & {d}_{1 N} \\ ⋮ & ⋱ & ⋮ \\ {d}_{M 1} & ⋯ & {d}_{MN}\end{matrix} )$$

In an example embodiment, the test selection system 105 reduces the attributes to the same L dimension to avoid an imbalance of weights among the four types of attributes, due to an imbalance in the item counts.

At 208, the test selection system 105 calculates cosine similarity between reduced dimension attributes of each test case and the target test scenario to measure the similarity between the two test cases (i.e., a test case from the plurality of test cases and a target test case). In an example embodiment, the test selection system 105 calculates the similarity between vector representations of the reduced dimension attributes.

$${S}_{tc i , tc j} = \frac{{\sum }_{k = 1}^{4 \cdot L} {V}_{tc i , attribute k} \cdot {V}_{tc j , attribute k}}{\sqrt{{\sum }_{k = 1}^{4 \cdot L} {( {V}_{tc i , attribute k} )}^{2}} \cdot \sqrt{{\sum }_{k - 1}^{N} {( {V}_{tc j , attribute k} )}^{2}}}$$

The test selection system 105 integrates both the static attributes and dynamic performance attributes to provide a more comprehensive evaluation of the test cases in the plurality of test cases.

At 210, the test selection system 105 selects test cases from the plurality of test cases having similarity matching scores greater than or equal to a threshold value. In an example embodiment, the test cases that meet the similarity matching score>=to a threshold Θ are selected to be added to a test case plan list for the test cases to be executed for the target issue and/or target release. In an example embodiment, the test selection system 105 then outputs the test case plan list comprising the selected test cases (that meet the similarity matching score).

In an example embodiment, the software testing life cycle system 101 executes the selected test cases on the test systems 102-N.

Accordingly, the particular processing operations and other functionality described in conjunction with the flow diagram of FIG. 2 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to provide an intelligent test case selection with performance influencing factors taken into consideration. These and other embodiments can effectively improve creation of an optimized and efficient test plan to target either external customer issues, or internal bug issues. Embodiments disclosed herein combine static parameters and/or matching feature tags with historical test case performance to optimize test case selection. Embodiments disclosed herein consider performance influencing factors when selecting test cases. It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the information processing system 100. For example, containers can be used to implement respective processing devices providing compute and/or storage services of a cloud-based system. Again, containers may be used in combination with other virtualization infrastructure such as virtual machines implemented using a hypervisor.

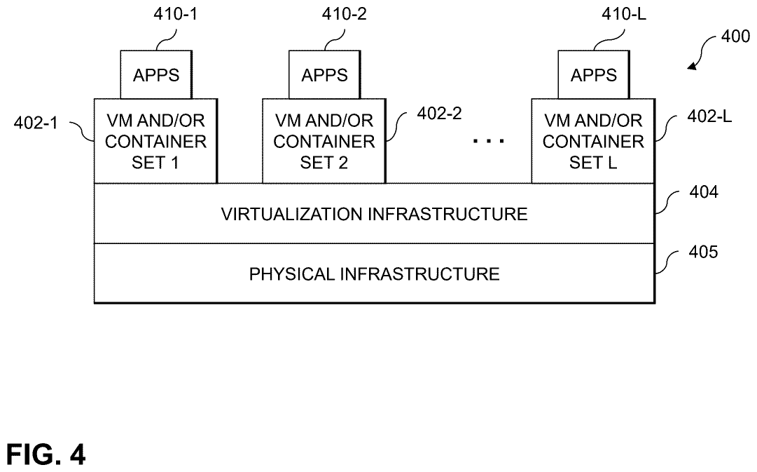

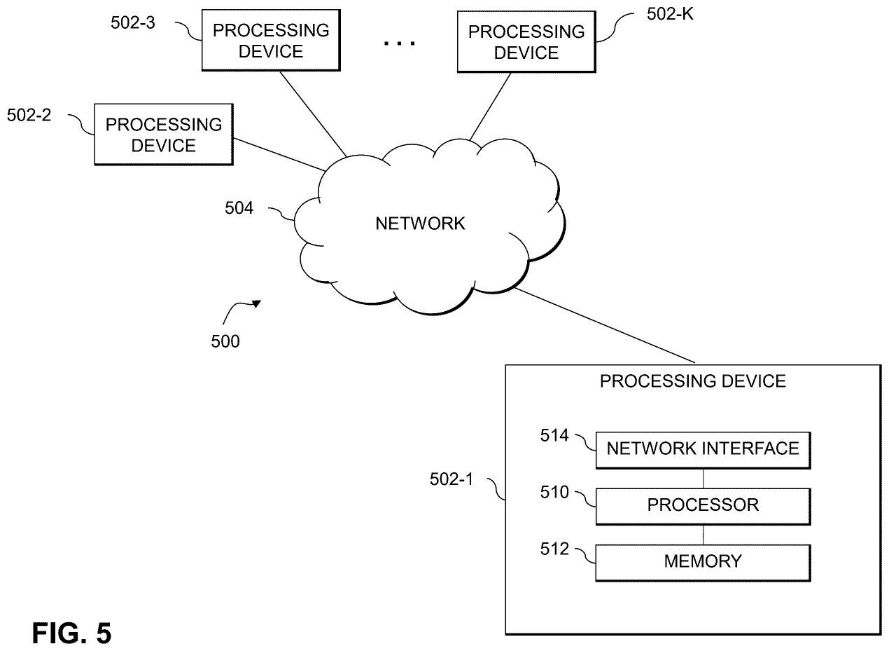

Illustrative embodiments of processing platforms will now be described in greater detail with reference to FIGS. 4 and 5. Although described in the context of the information processing system 100, these platforms may also be used to implement at least portions of other information processing systems in other embodiments.

FIG. 4 shows an example processing platform comprising cloud infrastructure 400. The cloud infrastructure 400 comprises a combination of physical and virtual processing resources that are utilized to implement at least a portion of the information processing system 100. The cloud infrastructure 400 comprises multiple virtual machines (VMs) and/or container sets 402-1, 402-2, . . . 402-L implemented using virtualization infrastructure 404. The virtualization infrastructure 404 runs on physical infrastructure 405, and illustratively comprises one or more hypervisors and/or operating system level virtualization infrastructure. The operating system level virtualization infrastructure illustratively comprises kernel control groups of a Linux operating system or other type of operating system.

The cloud infrastructure 400 further comprises sets of applications 410-1, 410-2, . . . 410-L running on respective ones of the VMs/container sets 402-1, 402-2, . . . 402-L under the control of the virtualization infrastructure 404. The VMs/container sets 402 comprise respective VMs, respective sets of one or more containers, or respective sets of one or more containers running in VMs. In some implementations of the FIG. 4 embodiment, the VMs/container sets 402 comprise respective VMs implemented using virtualization infrastructure 404 that comprises at least one hypervisor.

A hypervisor platform may be used to implement a hypervisor within the virtualization infrastructure 404, where the hypervisor platform has an associated virtual infrastructure management system. The underlying physical machines comprise one or more distributed processing platforms that include one or more storage systems.

In other implementations of the FIG. 4 embodiment, the VMs/container sets 402 comprise respective containers implemented using virtualization infrastructure 404 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of the information processing system 100 may each run on a computer, server, storage device or other processing platform element. A given such element is viewed as an example of what is more generally referred to herein as a “processing device.” The cloud infrastructure 400 shown in FIG. 4 may represent at least a portion of one processing platform. Another example of such a processing platform is processing platform 500 shown in FIG. 5.

The processing platform 500 in this embodiment comprises a portion of the information processing system 100 and includes a plurality of processing devices, denoted 502-1, 502-2, 502-3, . . . 502-K, which communicate with one another over a network 504.

The network 504 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 502-1 in the processing platform 500 comprises a processor 810 coupled to a memory 512.

The processor 510 comprises a microprocessor, a microcontroller, an application-specific integrated circuit (ASIC), a field-programmable gate array (FPGA) or other type of processing circuitry, as well as portions or combinations of such circuitry elements.

The memory 512 comprises random access memory (RAM), read-only memory (ROM) or other types of memory, in any combination. The memory 512 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 502-1 is network interface circuitry 514, which is used to interface the processing device with the network 804 and other system components, and may comprise conventional transceivers.

The other processing devices 502 of the processing platform 500 are assumed to be configured in a manner similar to that shown for processing device 502-1 in the figure.

Again, the particular processing platform 500 shown in the figure is presented by way of example only, and the information processing system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of a distributed processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A method comprising:
periodically updating, by a test selection system, dynamic performance attributes and static attributes of a plurality of test cases, wherein the dynamic performance attributes comprise performance information collected from a plurality of historical test case executions;
receiving, by the test selection system, a target test scenario comprising recommended test attribute information;
obtaining, by the test selection system, current static and dynamic performance attributes for the plurality of test cases;
calculating, by the test selection system, similarity matching scores between each test case and the target test scenario;
calculating, by the test selection system, cosine similarity between reduced dimension attributes of each test case and the target test scenario;
selecting, by the test selection system, test cases from the plurality of test cases having similarity matching scores greater than or equal to a threshold value; and
outputting, by the test selection system, a test case plan list comprising the selected test cases, wherein the method is implemented by at least one processing device comprising a processor coupled to a memory.

2. The method of claim 1, wherein the dynamic performance attributes comprise CPU usage, memory usage, IOPS (Input/Output Operations Per Second), and latency.

3. The method of claim 1 wherein the plurality of historical test case executions is based on at least one of
selecting a predetermined number of latest historical test case executions and selecting historical test case executions occurring after a specified time.

4. The method of claim 3 wherein selecting historical test case executions occurring after a specified time comprises: selecting test executions that occurred after a specified calendar date.

5. The method of claim 1 wherein the static attributes comprise hardware configurations, software configurations, and feature tags.

6. The method of claim 5 wherein the hardware configurations comprise at least one of: hardware type, disk configuration, and power action support.

7. The method of claim 5 wherein the software configurations comprise at least one of: network file system (NFS) version, replication session count, node reboot settings, execution duration, and database type.

8. The method of claim 5 wherein the feature tags comprise at least one of: inline data reduction (ILD), space reclaim, prefetch, and feature identifiers.

9. The method of claim 1 wherein the performance information is collected from test executions performed on an array system, wherein the performance information reflects array performance while a test case is executed on the array.

10. The method of claim 1 wherein periodically updating, by the test selection system, comprises:
calculating an average performance value using weighted performance information from the plurality of historical test case executions.

11. The method of claim 10 wherein calculating the average performance value comprises:
applying weights to performance information from each selected historical test case execution, wherein a sum of the weights equals one.

12. The method of claim 11 wherein the weights are equal for each selected historical test case execution.

13. The method of claim 1 wherein the target test scenario is provided by an expert based on a new requirement, wherein the new requirement comprises at least one of an external customer issue or an internal fixed bug issue.

14. The method of claim 1 wherein calculating, by the test selection system, the similarity matching scores comprises:
performing dimension reduction on the static and dynamic performance attributes using multidimensional scaling (MDS) to generate the reduced dimension attributes.

15. The method of claim 14 wherein performing dimension reduction comprises:
reducing each of the static and dynamic performance attributes to a same number of dimensions.

16. The method of claim 14 wherein performing dimension reduction comprises:
reducing each of the static and dynamic performance attributes to avoid an imbalance of weights among the static and dynamic attributes.

17. The method of claim 14 wherein performing dimension reduction comprises:
generating a distance matrix representing Euclidean distances between test case attributes.

18. The method of claim 1 wherein calculating, by the test selection system, the cosine similarity comprises:
calculating similarity between vector representations of the reduced dimension attributes.

19. A system comprising:
at least one processing device comprising a processor coupled to a memory;
the at least one processing device being configured:
to periodically update, by a test selection system, dynamic performance attributes and static attributes of a plurality of test cases, wherein the dynamic performance attributes comprise performance information collected from a plurality of historical test case executions;
to receive, by the test selection system, a target test scenario comprising recommended test attribute information;
to obtain, by the test selection system, current static and dynamic performance attributes for the plurality of test cases;
to calculate, by the test selection system, similarity matching scores between each test case and the target test scenario;
to calculate, by the test selection system, cosine similarity between reduced dimension attributes of each test case and the target test scenario;
to select, by the test selection system, test cases from the plurality of test cases having similarity matching scores greater than or equal to a threshold value; and
to output, by the test selection system, a test case plan list comprising the selected test cases.

20. A computer program product comprising a non-transitory processor-readable storage medium having stored therein program code of one or more software programs, wherein the program code when executed by at least one processing device causes said at least one processing device:
to periodically update, by a test selection system, dynamic performance attributes and static attributes of a plurality of test cases, wherein the dynamic performance attributes comprise performance information collected from a plurality of historical test case executions;
to receive, by the test selection system, a target test scenario comprising recommended test attribute information;
to obtain, by the test selection system, current static and dynamic performance attributes for the plurality of test cases;
to calculate, by the test selection system, similarity matching scores between each test case and the target test scenario;
to calculate, by the test selection system, cosine similarity between reduced dimension attributes of each test case and the target test scenario;
to select, by the test selection system, test cases from the plurality of test cases having similarity matching scores greater than or equal to a threshold value; and
to output, by the test selection system, a test case plan list comprising the selected test cases.
